(19) United States
(12) Patent Application Publication
(10) Pub. No.: US 2007/0097585 A1
(43) Pub. Date: May 3, 2007

(54) Apparatus for preventing static electricity and electric shock for mobile communication terminal

(75) Inventors: Joo-Hun Sung, Seongnam-si (KR); Hong-Gu Kim, Hwaseong-si (KR); Jae-Kwang Lee, Suwon-si (KR)

Correspondence Address: THE FARRELL LAW FIRM, 333 EARLE OVINGTON BOULEVARD., SUITE 701, UNIONDALE, NY, 11553, US

(73) Assignee: Samsung Electronics Co., Ltd., Suwon-si (KR)

(21) Appl. No.: 11/591,982

(22) Filed: Nov. 2, 2006

(30) Foreign Application Priority Data
Nov. 3, 2005 (KR) 2005-104874

(51) Int. Cl. H02H 9/06

(52) U.S. Cl. 361/118

(57) ABSTRACT

An apparatus for preventing static electricity and electric shock for a mobile communication terminal is disclosed having a main body housing that is partially or entirely made of a conductive material. The apparatus includes a ground of a Printed Circuit Board (PCB) and a diode-varistor parallel circuit connected to the ground of the PCB to form a discharge path.

### PRIORITY

This application claims priority under 35 U.S.C. § 119 to an application entitled “Apparatus for Preventing Static Electricity and Electric Shock for Mobile Communication Terminal” filed in the Korean Intellectual Property Office on Nov. 3, 2005 and assigned Serial No. 2005-104874, the contents of which are incorporated herein by reference.

### BACKGROUND OF THE INVENTION

1. Field of the Invention

The present invention generally relates to an apparatus for preventing static electricity and an electric shock for a mobile communication terminal having a main body housing that is partially or entirely made of a conductive material.

2. Description of the Related Art

Mobile communication terminals such as cellular phones are electronic apparatuses that users carry close to their bodies almost all the time. In consideration of portability, design of the mobile communication terminal has progressed toward slimness. To offset a degradation of durability that may be may accompany a slimmer terminal, a main body housing is made of metal, e.g., magnesium. However, to manufacture the main body housing with metal, safety measures regarding an accidental electric shock or static electricity discharge should be established. In other words, an electric shock occurring when a user's skin contacts a conductive material such as metal or conductive plastic could be fatal to a user or cause unpleasant feeling even if it is not harmful to the user.

Electro-static discharge may cause malfunction of the terminal. The voltage of static electricity is very high, ranging from several thousands to several tens of thousands of volts. Static electricity, though having very high voltage, has a state where current hardly flows. Thus, static electricity has a low risk of causing electric shock, but it may cause discomfort when it comes in contact with a user's skin. The high instantaneous voltage of static electricity may cause a fire with a flame or malfunction of a fine circuit of an electronic device. For example, an electronic part may be affected by an electromagnetic wave generated during electro-static discharge or may be damaged by a high instantaneous voltage.

Static electricity may be generated by various causes such as contact with skin and charging. Since many discharge paths are generated during charging, a significant amount of static electricity may be generated. The influence of an electric shock upon a human body or the degree of the risk of the electric shock varies with physical features or individual circumstances. However, the degree of risk electric shock poses to the human body may be determined by the magnitude of electric shock current, the duration of the electric shock, the channel of the electric shock, and the type of power supply.

A human body cannot sense electric shock current having a magnitude that is smaller than a specific threshold and can sense electric shock current having a magnitude that is larger than the specific threshold. The specific threshold is called a minimum sensible current that is 2-5 mA in case of direct current and is 0.5-2.0 mA in case of alternative current at a commercial frequency of 60 Hz. When the electric shock current exceeds the minimum sensible current, the human body gradually feels pain. Current that can be endured and does not endanger life is referred to as let-go-current and its magnitude is about 7-8 mA in case of alternative current for adult men.

Therefore, in the manufacturing of products, permissible touch voltage and current should be determined in terms of human body safety and various conditions such as a surrounding environment should be considered.

In addition, since static electricity performance and electric shock performance have a reciprocal relationship, if one improves, the other may degrade. Thus, it is important to configure a protection device preventing not only static electricity but also an electric shock. Efficiency such as the number of parts or installation space must also be considered.

### SUMMARY OF THE INVENTION

It is, therefore, an object of the present invention to provide an apparatus for preventing static electricity and an electric shock, which is designed to protect a human body from an electric shock and protect a mobile communication terminal from static electricity while impeding neither static electricity performance nor electric shock performance when the main body housing of a mobile communication terminal is partially or entirely made of a conductive material.

According to one aspect of the present invention, there is provided an apparatus for preventing static electricity and an electric shock for a mobile communication terminal having a main body housing that is partially or entirely made of a conductive material. The apparatus includes a ground of a Printed Circuit Board (PCB) and a diode-varistor parallel circuit connected to the ground of the PCB to form a discharge path.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the structure of an apparatus for preventing static electricity and an electric shock for a mobile communication terminal according to the present invention; and

FIG. 2 is a graph showing current conducting performance according to the present invention.

### DETAILED DESCRIPTION OF THE PREFERRED EMBODIMENTS

Preferred embodiments of the present invention will now be described in detail with reference to the annexed drawings. In the following description, a detailed description of well known functions and configurations incorporated herein has been omitted for conciseness.

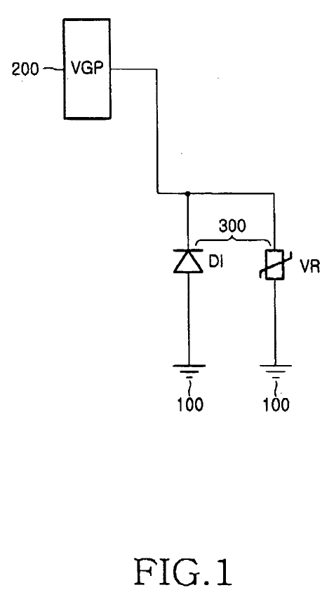

FIG. 1 illustrates the structure of an apparatus for preventing static electricity and an electric shock for a mobile communication terminal according to the present invention. A Virtual Ground Pad (VGP) 200 is formed on a Printed Circuit Board (PCB) and a diode DI and a varistor VR are connected to a main body housing of the mobile communication terminal. Here, the PCB refers to a main PCB of the mobile communication terminal.

A diode-varistor parallel circuit 300 is connected between a ground 100 of the PCB and the VGP 200.

When the mobile communication terminal is mounted on a charger (not shown), the ground 100 of the PCB is connected to the ground of the charger. Thus, if static electricity is applied to the VGP 200 that is connected, e.g., by a current-carrying tape, with a specific portion of a conductive main body housing, e.g., a slide hinge of a sliding phone, and a voltage exceeds a withstand voltage of the diode DI or the varistor VR of the diode-varistor parallel circuit 300, the diode DI or the varistor VR is broken down and a discharge path is generated. Thus, the static electricity is bypassed to the ground of the charger through the diode-varistor parallel circuit 300.

As mentioned above, the diode-varistor parallel circuit 300 is intended to minimize an influence of static electricity upon the mobile communication terminal and effectively discharge static electricity.

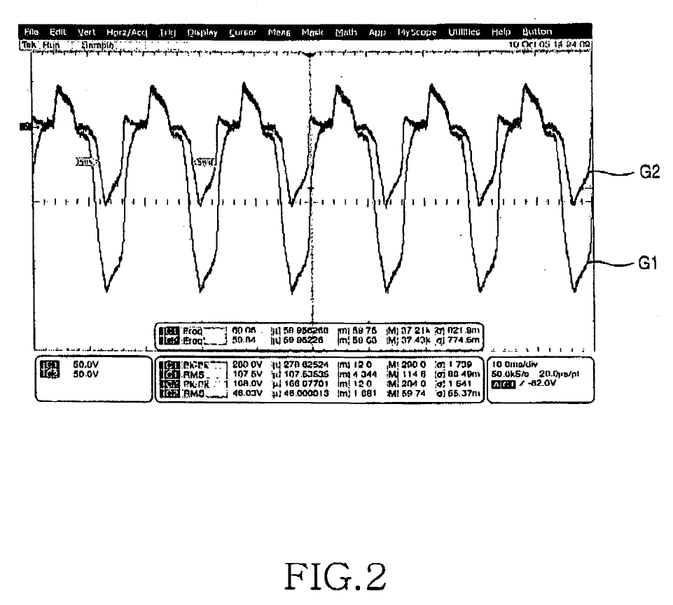

FIG. 2 is a graph showing current conducting performance according to the present invention.

G1 indicates a waveform of a signal detected from the ground 100 of the PCB and G2 indicates a waveform of a signal detected from the VGP 200. The waveform G2 detected from the VGP 200 appears at voltages higher and lower than 0V. The output of such a sine wave indicates that the VGP 200 passes current for both “+” and “−” polarities. This is because the apparatus of FIG. 1 can discharge harmful static electricity while effectively protecting a circuit by forming discharge paths for both “+” and “−” static electricity introduced to the VGP 200.

For example, when the power supply is AC 200V, a voltage detected from the ground 100 of the PCB is about 107.5V, as shown in FIG. 2. By using the apparatus of FIG. 1, the voltage detected from the VGP 200 can be reduced to about 46V.

Although not shown in FIG. 2, by using the apparatus of FIG. 1, current detected from the VGP 200 can be reduced to about 22 μA. The reduced current is lower than a half of 50 μA leakage current detected from the grounds 100 of the PCB, which does not cause unpleasant feeling even when directly exposed to a human body.

According to the present invention, for a mobile communication terminal having a main body housing that is partially or entirely made of a conductive material, by forming a discharge path, it is possible to prevent a harmful influence upon a human body, unpleasant feeling, or malfunction of the mobile communication terminal that may be caused by an electric shock or static electricity resulting from leakage current.

While the present invention has been shown and described with reference to preferred embodiments thereof, it will be understood by those skilled in the art that various changes in form and details may be made therein without departing from the spirit and scope of the invention, as defined by the appended claims.

What is claimed is:

1. An apparatus for preventing static electricity and electric shock for a mobile communication terminal having a main body housing that is partially or entirely made of a conductive material, the apparatus comprising:
a ground of a Printed Circuit Board (PCB); and
a diode-varistor parallel circuit connected to the ground of the PCB to form a discharge path.

2. The apparatus of claim 1, further comprising a Virtual Ground Pad (VGP) formed on the PCB to connect the ground of the PCB with the diode-varistor parallel circuit.

3. The apparatus of claim 2, wherein if the mobile communication terminal is mounted on a charger, static electricity applied to the VGP through the main body housing is bypassed to the ground of the charger through the diode-varistor parallel circuit and the ground of the PCB.

4. The apparatus of claim 2, wherein if the mobile communication terminal is mounted on a charger, when a voltage increases higher than a withstand voltage of a diode of the diode-varistor parallel circuit due to leakage current, the discharge path along the diode-varistor parallel circuit, the ground of the PCB, and the ground of the charger is formed.
